(19) United States
(12) Patent Application Publication
(10) Pub. No.: US 2008/0217316 A1
(43) Pub. Date: Sep. 11, 2008

(54) Steam Generator For an Autoclave

(75) Inventor: Daniele Ongaro, Villa Di Serio (Bergamo) (IT)

Correspondence Address: YOUNG & THOMPSON, 209 Madison Street, Suite 500, ALEXANDRIA, VA, 22314, US

(73) Assignee: W & H STERILIZATION S.R.L., Pedrengo (Bergamo (IT)

(21) Appl. No.: 11/995,580

(22) PCT Filed: Jul. 13, 2006
(86) PCT No.: PCT/IB2006/052401

§ 371 Date: Jan. 14, 2008

(30) Foreign Application Priority Data
Jul. 14, 2005 (IT) M12005A001342

(51) Int. Cl. F27D 11/00

(52) U.S. Cl. 219/407; 422/26

(57) ABSTRACT

A steam generator assembly for a sterilization chamber of a surgery autoclave is described, of the type comprising a steam generation compartment and a heating element, wherein the steam generation compartment has at least one portion made of polymeric material, the compartment preferably including a metal tray adjacent to a heating element.

The present invention refers to a steam generator for an autoclave, in particular to an autoclave for the sterilisation of dental handpieces and tools.

As known, all types of sterilising autoclaves, in particular autoclaves for dental surgeries, also comprise a steam generator, suitable to create the steam which is later channelled into the sterilisation chamber at different times and in different quantities according to the desired work cycle.

According to the prior art, the steam generator is formed as a sealable container, made of a metal material, which comprises heating means, typically in the shape of an electrical resistance, at least one water inlet port and one or more outlet ports releasing the pressurised steam.

The generator must withstand the temperatures and pressures typical of the sterilising steam used in surgery autoclaves, i.e. pressures between −1 and +5 bar and steam temperatures up to 150° C. Therefore, the generator is usually made of stainless steel, formed at least partly by plastic deformation, partly welded to assemble various elements; in some cases it has been attempted to use an aluminium alloy, which is a much more workable and cheaper construction material, but which gives off substantial oxides and other residues into the steam.

With the current limitation on materials, the shape of generators too is rather standardised and it is not possible—for technological and cost reasons—to deviate from a substantially cylindrical shape. This means that all other adjustment components, valves, additional chambers and inlet/outlet pipes must be provided separately and connected to the generator through connection members. This implies a multitude of components which complicates general construction, increases bulk within the autoclave and decreases general process efficiency, negatively affecting manufacturing, running and maintenance costs.

Moreover, an additional problem experienced in prior art steam generators concerns the placing and controlling of the electrical resistance for heating.

This heating element comprising an electrical resistance is very often shaped as a cylindrical element housed inside the generator: this also implies, in addition to construction complication and to the release of residues into the steam, the need to keep this element immersed in water—to be able to better control operation thereof—with the resulting undesired formation of an unused pool of water which is permanently inside the generator.

Other solutions provide to wind a heating coil around the external wall of the generator, which coil transfers heat by conduction through the generator walls: as can be appreciated, this solution is not efficient. In other cases, the heating coil, possibly made of a material not releasing residues into the steam (for example Incoloy™), is immersed inside the generator. In any case, these coil constructions are difficult to thermally control and cause serious damage in case of malfunctioning of the energy supply control.

Finally, the known problem still exists today of preventing the water injection system from allowing water into the steam generator in case of low pressure conditions inside the latter—i.e. during the vacuum-creation phase in the sterilisation chamber. So far, this adjustment action has been achieved through driven valves (for example solenoid valves) installed in the water inlet pipe, or by employing complex injection devices: however, these systems are rather costly and reliability is dependent on that of electric control devices.

It is an object of the present invention to solve all the above-mentioned drawbacks. In particular, the present invention aims at providing a generator made of a more efficient material from an energetic point of view as well as from that of industrial workability, which may then be more advantageously formed. It is further intended to provide a resulting generator construction which allows to provide an efficient heating element, free from unpleasant effects of oxide release into the steam and suited to also withstand control system failures. Moreover, it is intended to provide a complete but compact generator assembly, comprising not only the generator itself, but also the control devices and the suitable integrated connections, so as to perform all the steam generation functions for an autoclave.

Finally, it is intended to provide such a generator which is also provided with inexpensive and reliable means to prevent undesired water entry into the generator during low-pressure phases.

Such objects are achieved through a generator assembly as described in its essential features in the accompanying main claim.

Other inventive aspects of the device are described in the dependant claims.

Further features and advantages of the device according to the invention will in any case be clearer from the following detailed description of a preferred embodiment of the same, given by way of example and shown in the accompanying drawings, wherein:

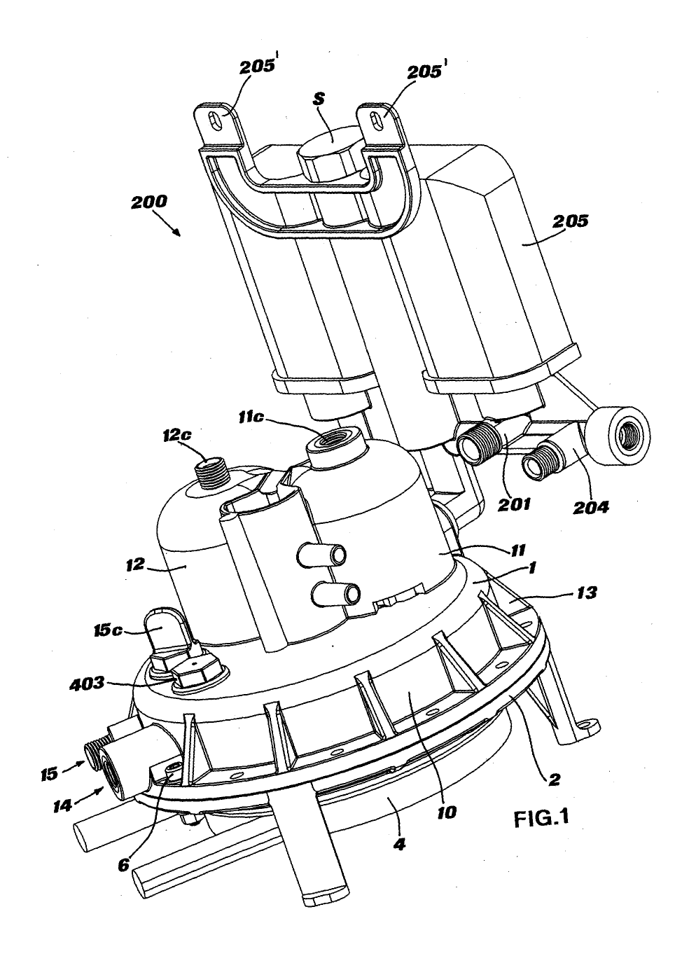

FIG. 1 is a perspective view of the full generator assembly according to the invention;

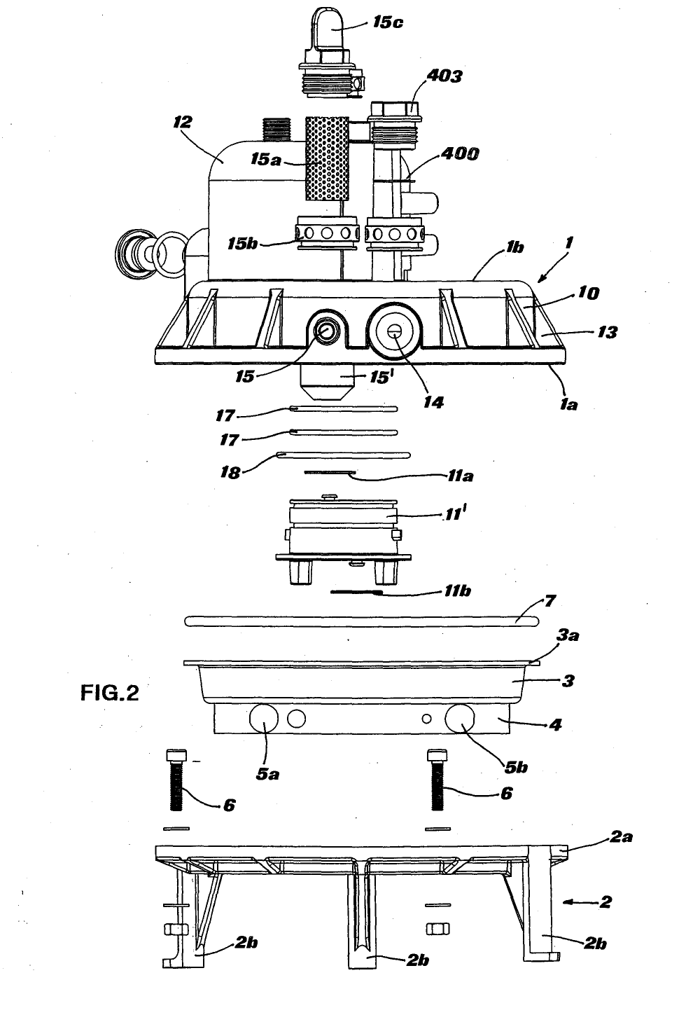

FIG. 2 is an exploded view of the generator according to the invention;

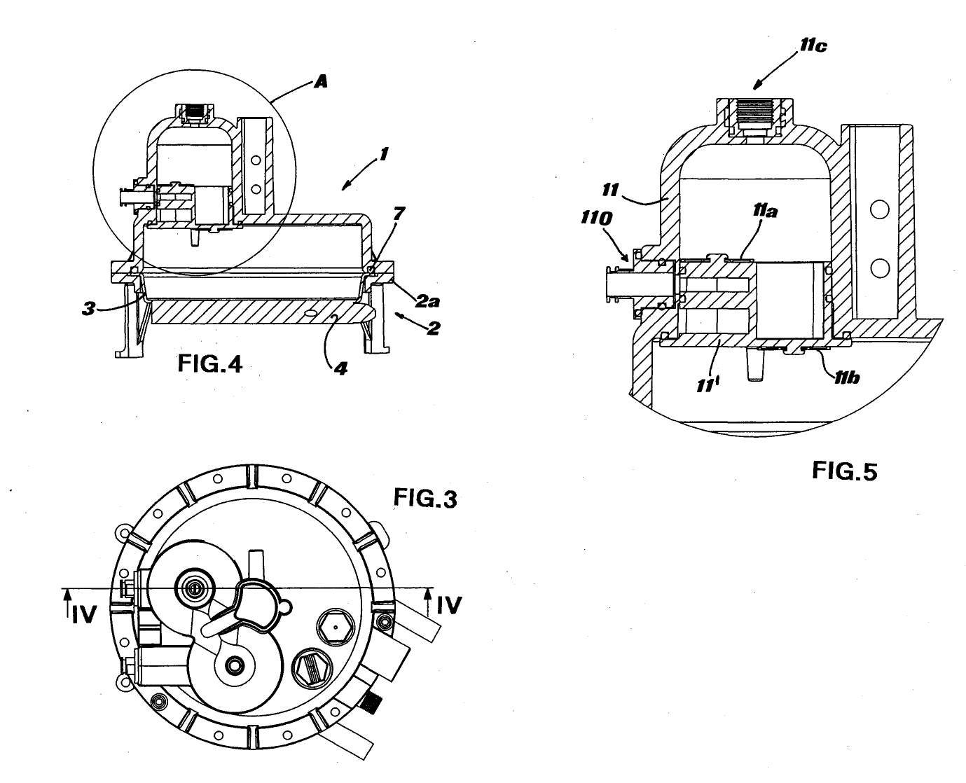

FIG. 3 is a top plan view of the generator of FIG. 2;

FIG. 4 is a cross-section view along the line IV-IV of FIG. 3;

FIG. 5 is an enlarged view of the detail encircled in A of FIG. 4;

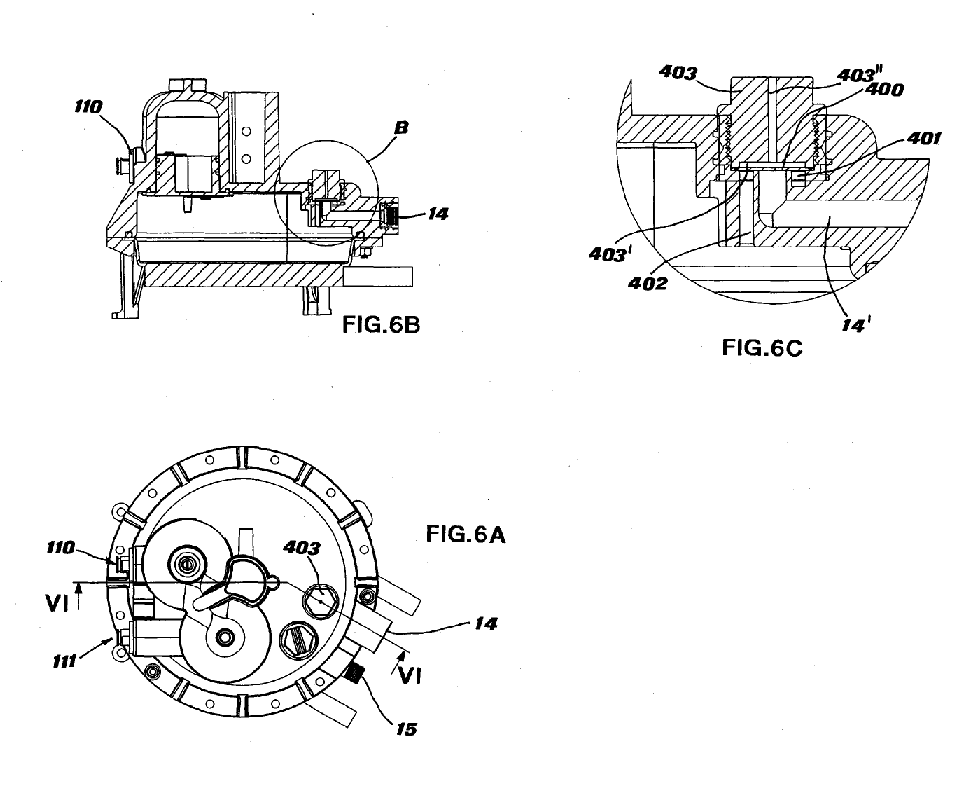

FIG. 6A is a plan view as in FIG. 3;

FIG. 6B is a cross-section view along the line VI-VI of FIG. 6A;

FIG. 6C is an enlarged view of the detail encircled in B of FIG. 6B;

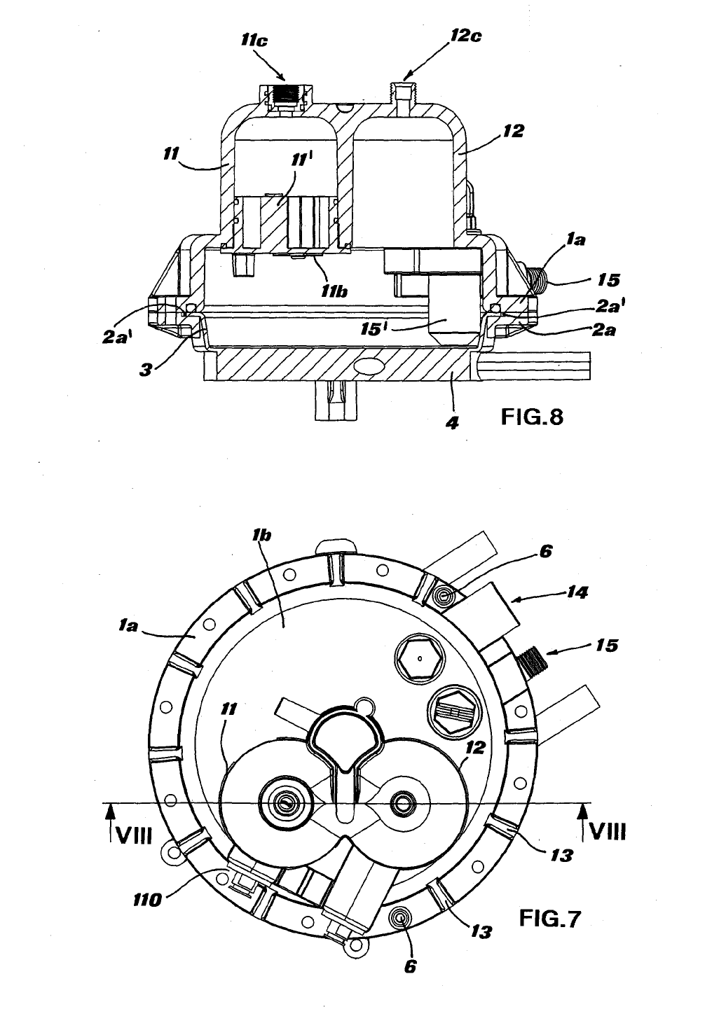

FIG. 7 is a plan view as in FIG. 3;

FIG. 8 is a cross-section view according to the line VIII-VIII of FIG. 7;

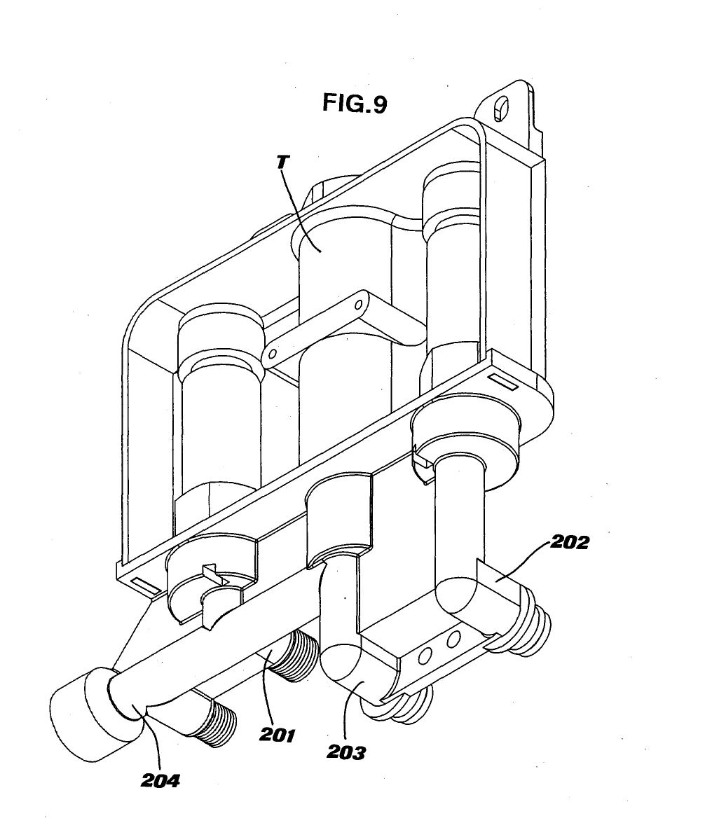

FIG. 9 is a perspective view of the valve support according to the invention;

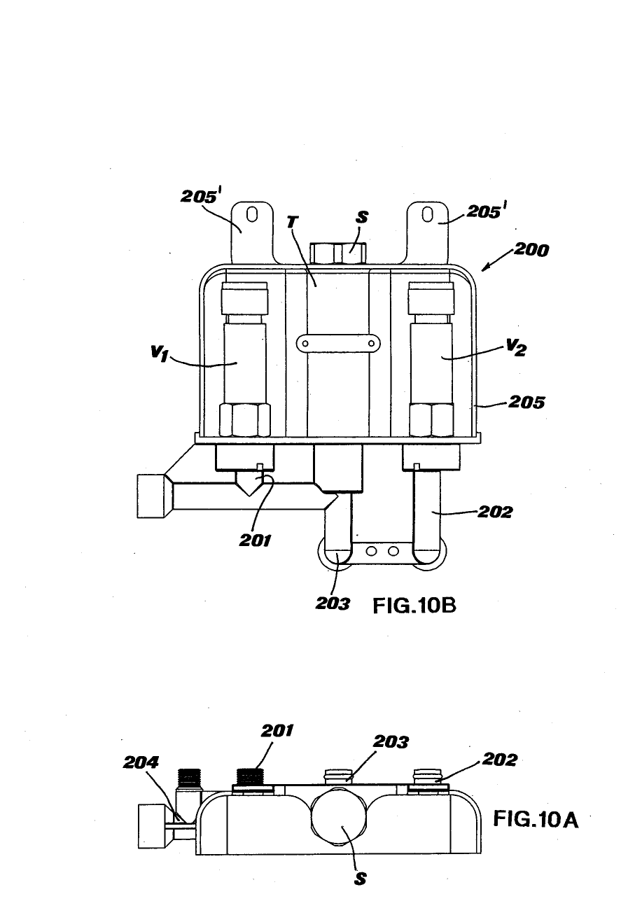

FIGS. 10A, 10B and 10C are a top plan view, an elevation rear view and an elevation side view, respectively, of the valve support of FIG. 9;

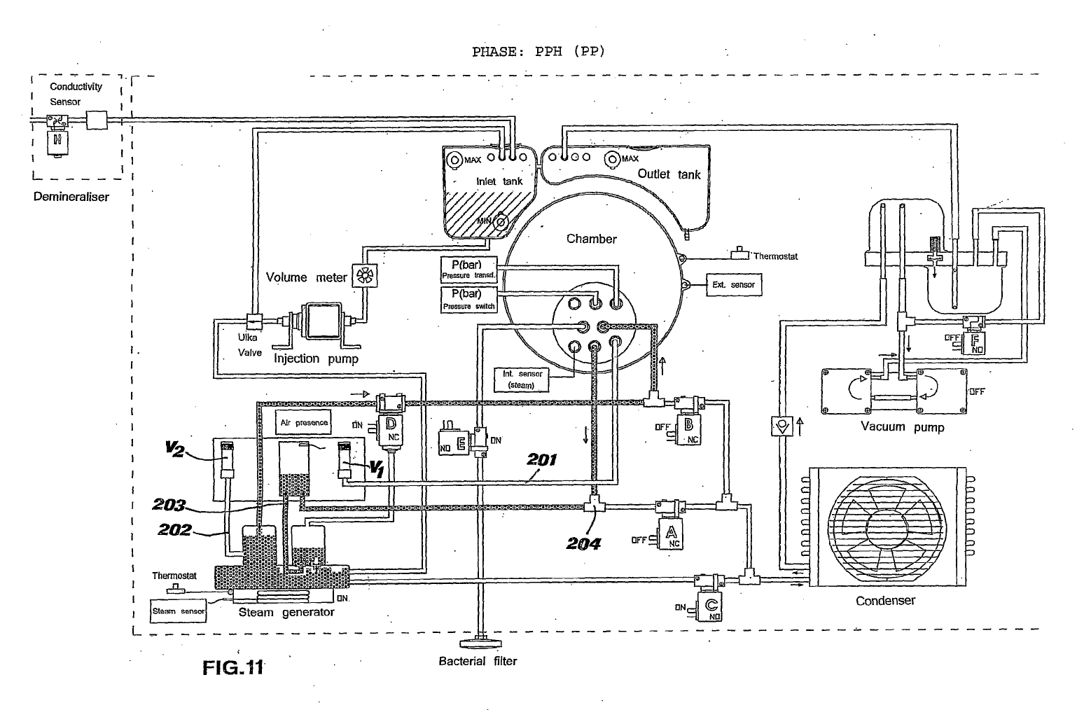

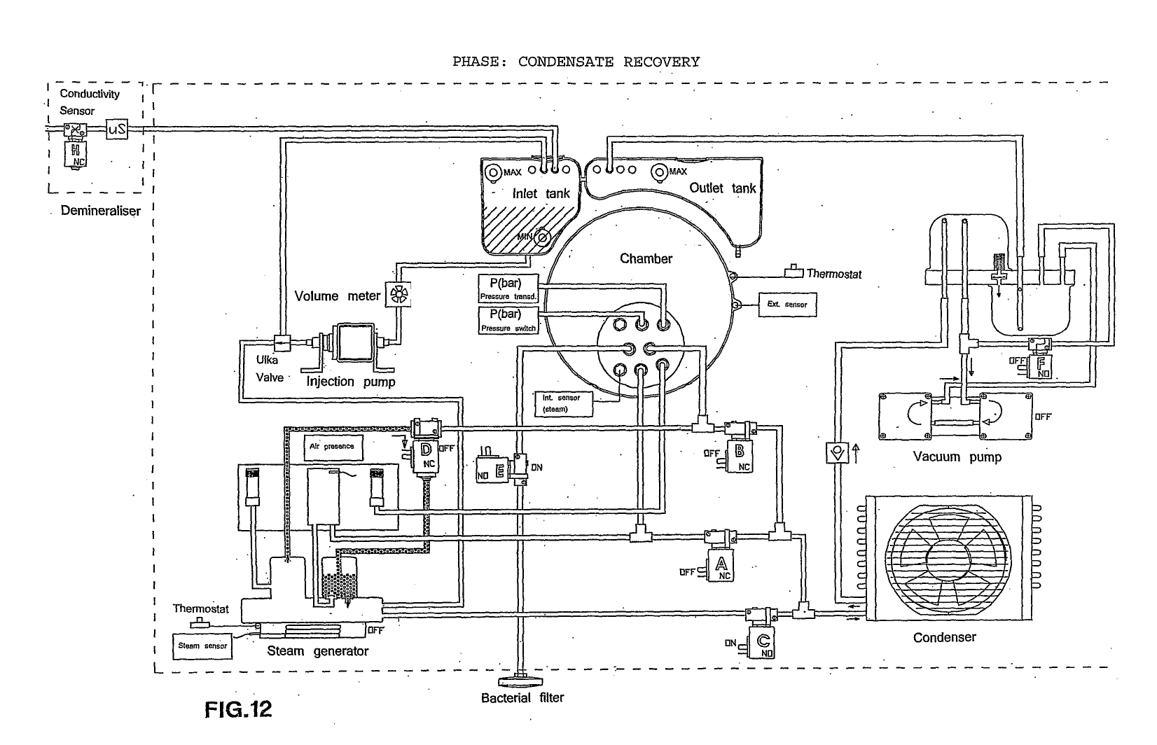

FIGS. 11 and 12 are diagrammatical views of the circuit diagram of an autoclave wherein the assembly of the invention is employed, in two different operation phases.

The Applicant, in an attempt to answer the many unsolved prior art problems, has taken a fully innovative approach to the construction of the generator, wondering first of all if it was not desirable to overcome the bias existing in the field and identifying a completely new construction solution. Following in-depth research and testing, the Applicant has identified an innovative family of materials which proved suitable for the manufacturing of a steam generator, at least for the specific application field considered here.

In particular, the generator according to the invention is made of a polymeric material, such as glass-filled polyetherimide (for example Ultem® 2300 available from General Electric Company) or equivalent materials.

This polymeric material exhibits a series of great construction opportunities, owing to its specific physical features of sturdiness but also of workability, which allow it to take on extremely complex shapes through moulding techniques.

On the other hand, the low thermal conductivity of the polymeric material advantageously results in the steam generation process being more energy efficient than the prior art.

Due to the employed material, generator design according to the invention may be better suited to the efficiency and cost requirements peculiar of a steam generation cycle for a sterilising machine. In such respect, a particularly advantageous embodiment is the one shown in the accompanying drawings.

As is well visible in FIGS. 1 and 2, the generator consists of an upper body 1 coupled with a lower support 2, both moulded of a polymeric material, between which a tray or metal pan 3 is placed.

Metal pan 3, advantageously made of stainless steel, is joined in its lower part to a heating element 4, for example a plate of an aluminium alloy wherein electrical resistances are embedded which protrude with terminals 5a and 5b.

The lower support of generator 2 is substantially shaped as a circular crown 2a, wherefrom a series of support stands 2b depart below. Crown 2a defines a wide central circular opening into which pan 3 is intended to be introduced. For such purpose, heating pan 3 has a circumferential flange 3a, intended to be housed in a corresponding stubbling 2a′ of crown 2a (see FIG. 8) and abutting therewith.

This construction allows heating plate 4 to remain external and sufficiently spaced apart from support 2, protruding below (FIG. 4), and allows flange 3a of the pan to remain flush with or below the upper surface of circular crown 2a.

Above lower support body 2, upper body 1 of the generator is applied, which similarly has a circular flange 1a intended to be coupled with circular crown 2a of lower support 2. Thanks to the fact that flange 3a of the pan remains fully housed in stubbling 2a′, crown 2a and flange 1a may be mutually, sealingly tightened with suitable tightening means, for example bolt means 6. Between the two, there is preferably provided an elastomeric gasket, for example an O-ring 7.

A generator compartment or sealed chamber is thereby obtained, defined by upper body 1 above and by heating pan or tray 3 below.

The construction of upper body 1, thanks to the fact that it can be manufactured of a mouldable polymeric material, can be selected so as to perfectly meet requirements of generator efficiency and functionality. In particular, in the following a preferred embodiment will be shown which also allows to exploit at best some teachings set forth in EP-A-1273311 in the name of the same Applicant, which is hereby incorporated by reference.

As is clearly shown in FIGS. 2 and 8, the upper body is manufactured integrally and comprises a cylindrical side wall 10, wherefrom flange 1a extends, which closes above into a closing plane 1b wherefrom two domes 11 and 12 depart. Thereby upper body 1 formed with the two domes 11 and 12 defines, together with the tray of intermediate pan 3, the steam generation chamber or compartment, which steam may hence rise into both domes 11 and 12.

Since the thus-defined compartment is intended to be repeatedly pressurised and de-pressurised during the operating cycle of the autoclave, the thickness of the entire upper body 1 is proportional to the desired mechanical strength, depending on the material employed. For example, using Ultem® 2300, wall thickness may be of about 5 mm. Preferably, strengthening ribs 13 are provided between flange 1a and cylindrical wall 10, for example eleven ribs which are evenly spaced apart.

Advantageously, domes 11 and 12 are mutually tangential and part of the sectioning wall is shared. Moreover, they are located as off-centre as possible from the centre of the upper closing plane 1b. These two devices contribute to make the entire generator construction even sturdier.

The function of the two domes 11 and 12, one provided with a valve body and the other one fully and freely communicating with the generator compartment, will not be set forth in detail here, since it has already been described in EP 1273311.

Inside dome 11 a valve body 11′ is provided, equipped with a pair of membrane valves, an upper one 11a and a lower one 11b, which allow liquid to flow upwards only (i.e. towards the dome inside) and downwards only (i.e. from the dome towards the generator inside), respectively. Valve body 11′ is obtained as a separate component, for example by moulding, and is mounted inside dome 11 with suitable holding means and a series of sealing gaskets, such as O-rings 17 and 18. On the side wall of dome 11, an access port is provided, wherein a connection 110 is mounted in communication with valve body 11′ and with upper valve 11a. Connection 110 is also in communication with the sterilisation chamber of the autoclave (diagrammatically shown only in FIGS. 11 and 12), through a duct integral with a support of safety valves 200, which will be described in the following. Through connection 110, the steam contained in the sterilisation chamber—during the pressurisation phase, with the generator not active—may be recalled into dome 11, which acts as a “cold plenum chamber”, through upper valve 11a.

Similarly, dome 12 has a connection 111 in communication with a safety valve, also through a duct of the support of safety valves 200 which will be described below.

Both domes 11 and 12 further have top ports, 11c and 12c, respectively, through which they are connected to a common valve (shown by letter D in the diagram of FIG. 11) communicating with the sterilisation chamber of the autoclave.

Water inlet and outlet into and from the generator is guaranteed by inlet ports 14 and outlet ports 15, respectively, obtained in the cylindrical side wall 10.

Outlet port 15 is connected with the inside of the generator compartment through a duct 15′ shaped as an upturned L, the inner end whereof ends at a short distance from the bottom of the generator compartment, i.e. close to the upper surface of pan 3 which forms the bottom surface of the generator compartment. It is thereby guaranteed that, in the condensate/water outlet phase, all the water remaining above pan 3 can be collected by pipe means 15′ and discharged through port 15 to a condenser (shown in FIGS. 11 and 12).

L-shaped pipe means 15′ further has an opening in the outer surface of upper plane 1b, through which a cylindrical filter 15a may be introduced and removed, kept in position by an annular support 15b and closed above by a threaded cap 15c. In order to aid cleaning operations and hence access to filter 15a, cap 15c is advantageously provided with an upper tab which may be operated manually.

Inlet port 14 is instead connected to a water injection device, diagrammatically shown by an injection pump and a self-actuating valve in FIGS. 11 and 12.

According to a preferred embodiment of the invention, inlet port 14 communicates with the inside of the generator compartment through a passive-valve device clearly shown in FIGS. 6B and 6C. Such device comprises an L-shaped pipe means 14′, which ends upwards in correspondence of a valve seat wherein a flexible disc-shaped membrane 400 is housed. Around the end of pipe means 14′, a groove 401 is obtained, which is in fluid communication with a further pipe 402 descending into the generator compartment. Groove 402, due to construction constraints, develops for example over an arch of about 270°.

Above membrane 400, a holding and sealing cap 403 is arranged, which may be screwed into the valve seat. Advantageously, cap 403 has a centred lower bell-shaped recess 403′, which allows membrane 400 a certain play, so that it may deform at least in its central part by a measure sufficient for its operation. Moreover, cap 403 has a venting hole 403″, designed to compensate the pressure above membrane 400.

This innovative construction with a passive-valve device is extremely advantageous in the emptying phase of the sterilisation chamber, i.e. when vacuum is created in said chamber.

As a matter of fact, in normal conditions, the pressure of the water channelled into port 14 through the injection pump and pushed up to the inner end of pipe means 14′ is sufficient to push and deform membrane 400 until water passes into the surrounding grove 401 and then into the generator through pipe 402. Conversely, when depression is created in the sterilisation chamber, depression is created in the generator too, and membrane 400 is hence recalled and retained towards groove 402 and consequently ends up strongly adhering to the mouth of the inner end of pipe means 14′. This condition leads to automatically seal—with no need of any actuating device—the end of pipe means 14′ and consequently makes it impossible for undesired water to enter the generator.

As can be guessed, this construction is extremely inexpensive, but at the same time it is effective and reliable and perfectly achieves one of the objects set forth in the preliminary remarks.

Both pipe means 14′ and 15′ ending in inlet ports 14 and outlet ports 15 are advantageously obtained integrally in the upper body 1 of the generator, for example employing removable plugs during the moulding phase.

FIGS. 9 and 10 further show a support for safety valves 200 to be employed in the generator assembly of the invention.

According to the preferred embodiment shown, support 200 consists of a lower portion equipped with a series of communication pipes and with an upper part housing two safety valves V1 and V2 as well as a temperature detection chamber T.

Valves V1 and V2 are safety valves (pressure relief valves) and are suited to limit the pressure of the sterilising chamber and of generator dome 12, respectively. For such purpose, valve V1 is mounted at the end of a pipe 201 which communicates exclusively with the sterilisation chamber. Valve V2 is instead mounted at the end of a pipe 202 which communicates exclusively with generator dome 12 (see also FIGS. 11 and 12).

The temperature detection chamber T is shaped as a small cylindrical chamber wherein a temperature probe S is housed; this construction allows to detect any leaks from the sterilisation chamber according to principles known per se, which will hence not be further described here. In order to allow the desired operation, temperature detection chamber T communicates with plenum-chamber dome 11 through a pipe 203, and with the condenser/sterilisation chamber assembly through a Y-joint 204.

Thanks to the compact construction shown, made possible by an equally efficient design of the generator according to the invention, support 200 may be advantageously obtained from a small number of mostly moulded components. In particular, the support may consist of a lower portion, moulded in a single piece, comprising all the pipes and a semi-portion of chamber T, and of an upper completion portion 205 comprising the other semi-portion of chamber T and a pair of fastening tabs 205′.

The proper temperature probe may be introduced into chamber T from above, through a suitable threaded opening, as shown by S in FIGS. 10A-10C.

In FIGS. 11 and 12, two phases typical of the operation cycle of an autoclave employing the generator assembly of the invention are finally shown.

FIG. 11 shows a PPH phase, i.e. a phase in which steam is generated and introduced in the sterilisation chamber. As can be seen, the steam produced in the generator rises into dome 12 and, through the corresponding pipe operated by valve D, is introduced in the sterilisation chamber.

FIG. 12 shows instead the condensate recovery phase.

As can be guessed, the inventive solution provided here comprises a series of remarkable advantages over the prior art.

Firstly, the use of glass-filled polymeric material for the manufacture of the generator allows to obtain a much more efficient and compact generator. The preferred construction shown, constructed by closing sandwich-like a metal pan integral with the heating element between two generator portions moulded in polymeric plastic material further allows to achieve improved control on heating, to remove any oxide release into the steam and to remarkably decrease manufacturing costs.

Moreover, the use of the passive valve device allows to prevent any problems of water entry during the vacuum phase, even at extremely low costs and with high reliability. Moreover, the specific design of the invention, with the membrane-shaped sealing element, requires no thrust-spring element, as is the case instead in a conventional ball check valve: there is hence never a significant counterpressure to be overcome—which in the prior art must be of at least 1 bar to prevent undesired openings of the valve—leading to improved precision of the line and of the water injection pump.

Finally, the compact arrangement of the safety valves and of the temperature detection chamber on a single support, comprising also the pipes communicating with the generator and the sterilisation chamber, implies manufacturing savings, increased assembly compactness and consequently improved accessibility and ease of mounting and inspection.

It is in any case understood that the invention is not limited to the specific embodiment illustrated above, which represents only a non-limiting example of the scope of the invention, but that a number of variants are possible, all within the reach of a person skilled in the field, without departing from the scope of the invention.

For example, the various communication ports may be shaped as holes threaded directly in the plastic material of the generator—in order to be able to join them to the connection pipes—or they may be shaped as separate, threaded, metal elements which are joined later or embedded during the moulding phase of the plastic material.

Moreover, the plan shape and the size of the generator compartment may also differ from those shown as examples, although exploiting the teachings provided here and outlined in the accompanying claims.

1-19. (canceled)

20. Steam generator assembly for a sterilisation chamber of a surgery autoclave, of the type comprising a steam generation compartment and a heating element, said steam generation compartment comprising a portion in the shape of domes made of polymeric material, characterized in that it consists of a metal pan or tray (3), to which a heating element (4) consisting of an aluminium plate or an alloy thereof wherein electric heating resistances are embedded is integral, coupled with said portion (1) made of polymeric material and in that said portion of polymeric material (1) of the generator is flanged and is joined to a flanged base portion (2), between which said metal tray (3) is retained sandwich-wise.

21. Assembly as in claim 20, wherein also said metal tray (3) has a flange (3a ) capable of being housed and retained in a stubbling (2a′) of one of the flanges (1a, 2a ) of said portion of polymeric material (1) or of the respective flanged, basic portion (2).

22. Assembly as in claim 20, wherein said portion made of polymeric material comprises two adjacent domes, a first dome (11) being provided with an inner valve body (11′) which separates said first dome from said compartment and a second dome (12) being in communication with said compartment and with a sterilisation chamber of the autoclave.

23. Assembly as in claim 22, wherein said inner valve body (11′) allows only fluid entry from a side joint (110) towards said first dome (11) and the transfer of said fluid from said first dome (11) towards said compartment.

24. Assembly as in claim 22, wherein said domes (11, 12) are integral with said portion of polymeric material by moulding.

25. Assembly as in claim 20, wherein said portion of polymeric material further has a water inlet port (14) and water outlet port (15) to and from said generator compartment, said inlet port (14) having a passive check valve device.

26. Assembly as in claim 25, wherein said passive check valve device consists of an L-shaped pipe means (14′) at the inner end whereof a flexible membrane (400) rests, which further covers a peripheral groove (401) in communication (402) with the inside of said generator compartment.

27. Assembly as in claim 26, wherein said flexible membrane (400) is kept in position by a small cap (403) which can be removed from a valve seat thereof.

28. Assembly as in claim 20, wherein said flanged base portion (2) is also made of polymeric material and is shaped as a circular crown (2a) wherefrom a plurality of support stands (2b) departs, capable of supporting the generator raised on a surface, the heating element (4) being housed inside the circular crown between said stands (2b).

29. Assembly as in claim 22, wherein a support for safety valves (200) is further provided, housing a first throttle valve (V1) for the sterilisation chamber and a second throttle valve (V2) for said second dome (12).

30. Assembly as in claim 29, wherein said support also comprises a temperature measuring chamber (T) equipped with a temperature probe (S).

31. Assembly as in claim 29, wherein said support (200) is further provided with a series of ducts integral therewith which put at least said domes (11, 12) in communication with respective operating devices.

32. Assembly as in claim 20, wherein said polymeric material is glass-filled.

33. Assembly as in claim 32, wherein said polymeric material is glass-filled polyetherimide.
